(19) United States
(12) Patent Application Publication
(10) Pub. No.: US 2025/0042738 A1
(43) Pub. Date: Feb. 6, 2025

(54) PURIFICATION METHOD AND APPARATUS FOR AQUEOUS HYDROGEN PEROXIDE SOLUTION

(71) Applicant: DONGWOO FINE-CHEM CO., LTD., Iksan-si (KR)

(72) Inventors: Hong-Ki MIN, Iksan-si (KR); Dong-Seok SEO, Iksan-si (KR); Uk LEE, Iksan-si (KR)

(73) Assignee: DONGWOO FINE-CHEM CO., LTD., Iksan-si (KR)

(21) Appl. No.: 18/787,122

(22) Filed: Jul. 29, 2024

(30) Foreign Application Priority Data
Jul. 31, 2023 (KR) 10-2023-0099606

(51) Int. Cl. C01B 15/013

(52) U.S. Cl. CPC C01B 15/0135

(57) ABSTRACT

The present disclosure relates to a method and an apparatus for purifying an aqueous hydrogen peroxide solution. According to the present disclosure, it is possible to provide a method and an apparatus for purifying an aqueous hydrogen peroxide solution, which may control a generated gas because there is no partial drying of an ion-exchange resin when purifying the aqueous hydrogen peroxide solution using the ion-exchange resin, require no facility expansion, and may provide a high-purity aqueous hydrogen peroxide solution.

### TECHNICAL FIELD

The present disclosure relates to a method and an apparatus for purifying an aqueous hydrogen peroxide solution by passing the aqueous hydrogen peroxide solution through an ion-exchange resin.

### BACKGROUND ART

In general, hydrogen peroxide is highly soluble in water, ethanol, and ether, is weakly acidic in aqueous solutions due to partial dissociation of hydrogen ions thereof, has strong oxidizing power, and thus is used in paper and pulp bleaching processes or used in a wide range of applications, including industrial oxidizing agents and wastewater treatment agents. In particular, hydrogen peroxide is used for cleaning semiconductor wafers and for etching in semiconductor and display manufacturing processes. In semiconductor manufacturing processes, even fine dust or impurities on wafers may significantly affect the reliability of semiconductors and cause a decrease in semiconductor yield, and thus it is very important to use high-purity materials.

Therefore, aqueous hydrogen peroxide solutions with a very high purity are required in fine chemical fields such as the semiconductor industry field.

As a method for reducing impurities in aqueous hydrogen peroxide solutions, a method using an ion-exchange resin or a method using a reverse osmosis membrane has been proposed. However, the method using a reverse osmosis membrane has a problem in that the reverse osmosis membrane deteriorates and the maintenance rate thereof decreases as the reverse osmosis membrane is continuously contacted with high-concentration aqueous hydrogen peroxide solutions.

Where an aqueous hydrogen peroxide solution is purified using the ion-exchange resin, when hydrogen peroxide comes into contact with the ion-exchange resin, the decomposition reaction of the hydrogen peroxide occurs, resulting in heat or gas generation. For this reason, in a conventional art, an upflow process was designed such that an aqueous hydrogen peroxide solution would flow from bottom to top through an ion-exchange resin so that the generated gas could be smoothly discharged.

Where the upflow process is designed as described above, the ion-exchange resin floats upward, and hence the expansion of facilities such as a purification tower containing the ion-exchange resin is essential to increase productivity. However, since there is a limit to expanding the facilities, there is also a limit to improving the efficiency of purification of aqueous hydrogen peroxide solutions.

Accordingly, technology has been developed to overcome the above-described problem by designing a downflow process in which an aqueous hydrogen peroxide solution flows from top to bottom through an ion-exchange resin. However, in the downflow process, the ion-exchange resin may not be completely submerged in an aqueous hydrogen peroxide solution and may be exposed to the air. In this case, a portion of the ion-exchange resin may be dried, and due to the contact between the dried portion of the ion-exchange resin and the introduced aqueous hydrogen peroxide solution, gas generation may rapidly increase, which may increase the concentration of impurities.

Japanese Patent Application Publication No. 2006-077118 discloses a method for purifying an aqueous hydrogen peroxide solution, which includes a column containing an ion-exchange resin and may reduce the concentration of impurities by controlling the mixing ratio of cations and anions. However, there is still a problem in that gas generation may increase due to exposure of the ion-exchange resin to the air.

### PRIOR ART DOCUMENTS

### Patent Documents

(Patent Document 1) Japanese Patent Application Publication No. 2006-077118

### DISCLOSURE

### Technical Problem

An object of the present disclosure is to provide a method and an apparatus for purifying an aqueous hydrogen peroxide solution, which may maintain the level of the aqueous hydrogen peroxide solution in a purification tower at a constant level when purifying the aqueous hydrogen peroxide solution using an ion-exchange resin, and may stably discharge the gas generated during the purification of the aqueous hydrogen peroxide solution, thereby improving process stability.

Another object of the present disclosure is to provide a method and an apparatus for purifying an aqueous hydrogen peroxide solution, which may improve productivity by increasing purification capacity and purification rate without excessive facility expansion.

Still another object of the present disclosure is to provide a method and an apparatus for purifying an aqueous hydrogen peroxide solution, which may prevent a mixed contact reaction caused by drying of an ion exchange resin in a purification tower, thereby reducing unwanted gas generation and further improving ion exchange performance.

Yet another object of the present disclosure is to provide a method and an apparatus for purifying an aqueous hydrogen peroxide solution, which may provide a high-purity aqueous hydrogen peroxide solution.

However, objects of the present disclosure are not limited to the objects mentioned above, and other objects not mentioned above will be clearly understood by those skilled in the art from the following description.

### Technical Solution

To achieve the above objects, the present disclosure provides a method for purifying an aqueous hydrogen peroxide solution, including steps of: (a) performing purification of the aqueous hydrogen peroxide solution by introducing the aqueous hydrogen peroxide solution into a purification tower containing an ion-exchange resin; and (b) discharging the aqueous hydrogen peroxide solution through a discharge pipe connected to the bottom of the purification tower and including a liquid level maintenance portion, wherein, in step (a), the aqueous hydrogen peroxide solution is passed from top to bottom through the ion-exchange resin, and in step (b), the maximum height of the liquid level maintenance portion is equal to or greater than the height of the ion-exchange resin in the purification tower.

According to one embodiment of the present disclosure, the maximum height of the liquid level maintenance portion may be 110% or more, or 120% or more, of the height of the ion-exchange resin in the purification tower.

According to one embodiment of the present disclosure, the maximum height of the liquid level maintenance portion may be 140% or less, or 130% or less, of the height of the ion-exchange resin in the purification tower.

According to one embodiment of the present disclosure, the ion-exchange resin may be a mixed ion exchange resin consisting of a cation-exchange resin and an anion-exchange resin.

According to one embodiment of the present disclosure, the method may further include, after step (b), steps of: (c) transferring the aqueous hydrogen peroxide solution discharged in step (b) to an intermediate storage tank; and (d) transferring the aqueous hydrogen peroxide solution in the intermediate storage tank to a subsequent process or a final storage tank through a transfer pipe including a pump.

According to one embodiment of the present disclosure, the level of the hydrogen peroxide solution in the intermediate storage tank may be 30% or more of the internal height of the intermediate storage tank.

According to one embodiment of the present disclosure, step (d) may be performed using a transfer driving force provided by the pump.

According to one embodiment of the present disclosure, the entire process including steps (a) and (b) may be repeated to further increase the purity of the purified aqueous hydrogen peroxide solution.

The present disclosure also provides an apparatus for purifying an aqueous hydrogen peroxide solution, including: a purification tower containing an ion-exchange resin; and a discharge pipe connected to the bottom of the purification tower and having a liquid level maintenance portion, wherein the maximum height of the liquid level maintenance portion is equal to or greater than the height of the ion-exchange resin in the purification tower.

According to one embodiment of the present disclosure, the maximum height of the liquid level maintenance portion may be 110% or more, or 120% or more, of the height of the ion-exchange resin in the purification tower.

According to one embodiment of the present disclosure, the maximum height of the liquid level maintenance portion may be 140% or less, or 130% or less, of the height of the ion-exchange resin in the purification tower.

According to one embodiment of the present disclosure, the ion-exchange resin may be a mixed ion-exchange resin consisting of a cation-exchange resin and an anion-exchange resin.

According to one embodiment of the present disclosure, the purification device may further include an intermediate storage tank connected to the discharge pipe.

According to one embodiment of the present disclosure, the rear end of the intermediate storage tank may be connected to a transfer pipe, wherein the transfer pipe may include a pump.

### Advantageous Effects

According to the present disclosure, it is possible to provide a method and an apparatus for purifying an aqueous hydrogen peroxide solution, which may maintain the level of the aqueous hydrogen peroxide solution in a purification tower at a constant level when purifying the aqueous hydrogen peroxide solution using an ion-exchange resin, and may stably discharge the gas generated during the purification of the aqueous hydrogen peroxide solution, thereby improving process stability.

The present disclosure may also provide a method and an apparatus for purifying an aqueous hydrogen peroxide solution, which may improve productivity by increasing purification capacity and purification rate without excessive facility expansion.

The present disclosure may also provide a method and an apparatus for purifying an aqueous hydrogen peroxide solution, which may prevent a mixed contact reaction caused by drying of an ion exchange resin in a purification tower, thereby reducing unwanted gas generation and further improving ion exchange performance.

The present disclosure may also provide a method and an apparatus for purifying an aqueous hydrogen peroxide solution, which may provide a high-purity aqueous hydrogen peroxide solution by minimizing the generation of impurities when purifying the aqueous hydrogen peroxide solution using an ion-exchange resin.

### BRIEF DESCRIPTION OF DRAWINGS

FIG. 1 schematically illustrates an apparatus for purifying an aqueous hydrogen peroxide solution and a method of purifying an aqueous hydrogen peroxide solution using the same according to one embodiment of the present disclosure.

FIG. 2 schematically illustrates an apparatus for purifying an aqueous hydrogen peroxide solution and a method of purifying an aqueous hydrogen peroxide solution using the same according to another embodiment of the present disclosure.

### DETAILED DESCRIPTION

The present disclosure relates to a method and an apparatus for purifying an aqueous hydrogen peroxide solution by passing the aqueous hydrogen peroxide solution through an ion-exchange resin, and particularly, to a method and an apparatus for purifying an aqueous hydrogen peroxide solution, which may achieve the purity required in fine chemical fields and improve process stability and productivity.

More specifically, the present disclosure provides a method for purifying an aqueous hydrogen peroxide solution, including steps of: (a) performing purification of the aqueous hydrogen peroxide solution by introducing the aqueous hydrogen peroxide solution into a purification tower containing an ion-exchange resin; and (b) discharging the aqueous hydrogen peroxide solution through a discharge pipe connected to the bottom of the purification tower and including a liquid level maintenance portion, wherein, in step (a), the aqueous hydrogen peroxide solution is passed from top to bottom through the ion-exchange resin, and in step (b), the maximum height of the liquid level maintenance portion is equal to or greater than the height of the ion-exchange resin in the purification tower.

The present disclosure also provides an apparatus for purifying an aqueous hydrogen peroxide solution, including: a purification tower containing an ion-exchange resin; and a discharge pipe connected to the bottom of the purification tower and having a liquid level maintenance portion, wherein the maximum height of the liquid level maintenance portion is equal to or greater than the height of the ion-exchange resin in the purification tower.

The method for purifying an aqueous hydrogen peroxide solution according to the present disclosure refers to a method of obtaining an aqueous hydrogen peroxide solution with higher purity by removing impurities from an aqueous hydrogen peroxide solution synthesized in-house or purchased from a supplier.

Before being purified by the purification method according to the present disclosure, the aqueous hydrogen peroxide solution may contain undesirable amounts of contaminants and impurities. Through purification by the purification method according to the present disclosure, significant amounts of contaminants and impurities may be removed from the aqueous hydrogen peroxide solution.

The aqueous hydrogen peroxide solution before being purified by the purification method or purification apparatus according to the present disclosure is also referred to as “unpurified aqueous hydrogen peroxide solution”. The aqueous hydrogen peroxide solution purified by the purification method or purification apparatus according to the present disclosure is also referred to as “purified aqueous hydrogen peroxide solution”. The “purified aqueous hydrogen peroxide solution” may contain impurities at a limited concentration within a predetermined range.

In particular, it is preferable that a purified aqueous hydrogen peroxide solution for use in semiconductor processes has a sodium ion concentration of 10 ppt or less. The aqueous hydrogen peroxide solution purified by the purification method or purification apparatus according to the present disclosure may contain sodium ions at a concentration of 10 ppt or less.

Hereinafter, embodiments of the present disclosure will be described in more detail with reference to the drawings. However, the drawings attached to the present specification illustrate preferred embodiments of the present disclosure, and serve to further understand the technical idea of the present disclosure together with the detailed description of the present disclosure. Accordingly, the present disclosure should not be interpreted as being limited only to the matters shown in these drawings.

The terminology used herein is for the purpose of describing embodiments only and is not intended to limit the present disclosure. In the present specification, singular forms also include plural forms unless the context clearly dictates otherwise.

As used herein, the terms “comprises”, “comprising”, “includes”, “including”, “has”, and/or “having” are intended to denote the existence of one or more stated components, steps, operations, and/or devices, and do not exclude the probability of existence or addition of one or more other components, steps, operations, and/or devices. Like reference numerals refer to like components throughout the present specification.

Spatially relative terms, such as “below”, “lower (end or portion)”, “above”, “upper (end or portion)” and the like, may be used to easily describe the relationship between one component and another component(s) as illustrated in the figures. Spatially relative terms should be understood to encompass different orientations of the component in use or operation in addition to the orientation depicted in the figures

As used herein, the term “connection” is meant to encompass both indirectly connecting a plurality of components and directly connecting a plurality of components.

In the present specification, “ppb” means “parts per billion”, and “ppt” means “parts per trillion”.

### <Apparatus for Purifying Aqueous Hydrogen Peroxide Solution>

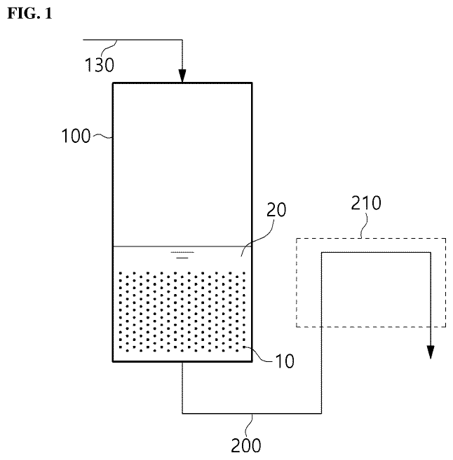

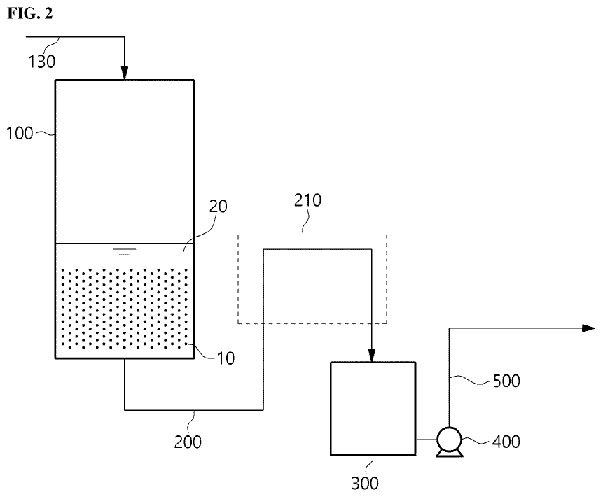

FIG. 1 schematically illustrates an apparatus for purifying an aqueous hydrogen peroxide solution and a method of purifying an aqueous hydrogen peroxide solution using the same according to one embodiment of the present disclosure, and FIG. 2 schematically illustrates an apparatus for purifying an aqueous hydrogen peroxide solution and a method of purifying an aqueous hydrogen peroxide solution using the same according to another embodiment of the present disclosure.

Referring to FIG. 1, the apparatus for purifying an aqueous hydrogen peroxide solution according to the present disclosure includes a purification tower 100 and a discharge pipe 200 through which the aqueous hydrogen peroxide solution purified through the purification tower 100 is discharged.

The discharge pipe 200 is connected to the bottom of the purification tower 100, so that the aqueous hydrogen peroxide solution purified in the purification tower 100 is discharged through the bottom of the purification tower 100. In addition, the discharge pipe 200 is characterized by including a liquid level maintenance portion (210).

The purification tower 100 may include an ion-exchange resin 10 therein, and an unpurified aqueous hydrogen peroxide solution is introduced thereinto through an injection pipe 130. The introduced unrefined aqueous hydrogen peroxide solution is purified while passing from top to bottom through the ion-exchange resin 10, and the purified aqueous hydrogen peroxide solution is discharged through the discharge pipe 200 connected to the bottom of the purification tower 100.

The ion exchange resin 10 may be packed to a height of 30 to 90%, preferably 30 to 80%, more preferably 30 to 70%, of the internal height of the purification tower 100, taking into consideration the control of gas generated in the purification tower 100 and the efficiency of purification of the aqueous hydrogen peroxide solution.

Here, it is preferable to maintain the level of the aqueous hydrogen peroxide solution 20 in the purification tower 100 at a level equal to or higher than the height of the ion-exchange resin 10 in order to prevent a part of the ion-exchange resin 10 in the purification tower 100 from being dried by exposure without being submerged in the aqueous hydrogen peroxide solution 20.

To this end, the present disclosure includes a liquid level maintenance portion 210 in the discharge pipe 200. By means of the liquid level maintenance portion 210, the level of the aqueous hydrogen peroxide solution 20 may be maintained at a level equal to or higher than the height of the ion-exchange resin 10.

In the present disclosure, the liquid level maintenance portion 210 means a part of the discharge pipe (200), which includes an inverted U-shaped bent portion. The liquid level maintenance portion 210 may have a shape bent so that the two ends thereof face in the same direction and the middle portion thereof protrudes in a direction different from the two ends. The shape of the bent portion is not limited to an inverted “U” shape, and may include an inverted modified “U” shape, an inverted “V” shape, or an inverted modified “V” shape.

It is preferable that the liquid level maintenance portion 210 has a diameter of 50 to 100 mm in terms of pressure loss in the pipe. In addition, considering the cost aspect of the pipe and pressure loss in the pipe, the distance of the liquid level maintenance portion 210 from the purification tower 100 is preferably 20 m or less.

In addition, it is preferable that the liquid level maintenance portion 210 be composed of the same material as the purification tower 100.

The inverted U-shaped bent portion is directed upward rather than toward the ground, and the top portion thereof becomes the maximum height of the liquid level maintenance portion 210.

The purified aqueous hydrogen peroxide solution that is transferred through the liquid level maintenance portion 210 passes through a section, where it is transferred in the direction opposite to gravity, before passing through the top of the inverted U-shaped bent portion which is the maximum height.

Accordingly, when the level of the aqueous hydrogen peroxide solution 20 in the purification tower 100 is higher than or equal to the maximum height of the liquid level maintenance portion 210, the purified aqueous hydrogen peroxide solution discharged from the purification tower 100 can pass through the liquid level maintenance portion 210. In contrast, when the level of the aqueous hydrogen peroxide solution 20 in the purification tower 100 is lower than the maximum height of the liquid level maintenance portion 210, the purified aqueous hydrogen peroxide solution discharged from the purification tower 100 cannot reach the maximum height of the liquid level maintenance portion 210 and thus cannot pass through the liquid level maintenance portion 210.

Therefore, when the maximum height of the liquid level maintenance portion 210 is equal to or higher than the height of the ion-exchange resin 10 in the purification tower 100, the level of the aqueous hydrogen peroxide solution 20 in the purification tower 100 may also be maintained at a level equal to or higher than the height of the ion-exchange resin 10. Thus, in this case, it is possible to fundamentally prevent a portion of the ion-exchange resin 10 in the purification tower 100 from being dried by exposure without being submerged in the aqueous hydrogen peroxide solution 20.

As the level of the aqueous hydrogen peroxide solution 20 in the purification tower 100 is maintained at a level equal to or higher than the height of the ion-exchange resin 10 by means of the liquid level maintenance portion 210 as described above, sufficient time may be secured for the aqueous hydrogen peroxide solution to pass through the ion-exchange resin, thereby increasing the purification efficiency and increasing the purity of the purified aqueous hydrogen peroxide solution.

Furthermore, the maximum height of the liquid level maintenance portion 210 may be 110% or more, preferably 120% or more, of the height of the ion exchange resin 10 in the purification tower 100. When the above numerical range is satisfied, there is an advantage in that, even if there is some swing in the level of the hydrogen peroxide solution 20 in the purification tower 100, the ion-exchange resin may be sufficiently submerged in the aqueous hydrogen peroxide solution, so that even when the purification process is performed, no exposed portion of the ion-exchange resin occurs, and thus the gas generated in the purification process may be controlled more stably.

In addition, the maximum height of the liquid level maintenance portion 210 may be 140% or less, preferably 130% or less, of the height of the ion-exchange resin 10 in the purification tower 100. When the above numerical range is satisfied, there is an advantage in that, even if there is a swing in the level of the hydrogen peroxide solution in the purification tower, the resin layer is not exposed, and sufficient space is ensured at the top of the purification tower, making it easy to control the gas generated in the purification tower.

The above liquid level maintenance portion 210 may have a symmetrical shape with respect to the top of the inverted U-shaped bent portion as shown in the figure, but is not limited thereto, and the left and right pipe portions with respect to the top of the inverted U-shaped bent portion may be formed to have different heights as needed.

In the present disclosure, the ion-exchange resin 10 that may be included in the purification tower 100 may be selected from among a cation-exchange resin, an anion-exchange resin, and a mixed ion-exchange resin. Among these resins, the mixed ion-exchange resin consisting of a cation-exchange resin and an anion-exchange resin is preferably used considering the efficiency of purification of the aqueous hydrogen peroxide solution.

The cation-exchange resin is not particularly limited as long as it can remove cationic impurities from the aqueous hydrogen peroxide solution. Specifically, the cation-exchange resin may be at least one selected from the group consisting of strongly acidic cation-exchange resins having a polystyrene matrix and a sulfonic acid group.

The anion-exchange resin is not particularly limited as long as it can remove anionic impurities from the aqueous hydrogen peroxide solution. Specifically, the anion-exchange resin may be at least one selected from the group consisting of strongly basic anion-exchange resins having a quaternary ammonium group in the styrene framework.

The cation-exchange resin and the anion-exchange resin may be included at a volume ratio of 0.8:1.0 to 1.0:0.8, and when the above volume ratio is satisfied, there is an advantage in that mutual purification of impurities generated from each ion-exchange resin is possible, which is preferable.

Referring to FIG. 2, the apparatus for purifying an aqueous hydrogen peroxide solution according to the present disclosure may further include an intermediate storage tank 300. The intermediate storage tank 300 is connected to the discharge pipe 200 connected to the bottom of the purification tower 100, so that the aqueous hydrogen peroxide water purified in and discharged from the purification tower 100 may be collected in the intermediate storage tank 300, and the aqueous hydrogen peroxide water in the intermediate storage tank 300 may be transferred to a subsequent process or a final storage tank through a transfer pipe 500.

The level of the aqueous hydrogen peroxide solution in the intermediate storage tank 300 may preferably be 30% or more of the internal height of the intermediate storage tank 300. When this is satisfied, there is an advantage in that it is possible to prevent a pump 400 described later from idling due to a drop in the level of the aqueous hydrogen peroxide solution.

The apparatus for purifying an aqueous hydrogen peroxide solution according to the present disclosure may further include a pump 400 connected to the rear end of the intermediate storage tank 300 and configured to provide a driving force to the transfer pipe 500.

If the pump 400 is provided upstream of the intermediate storage tank 300, i.e., downstream of the purification tower 100, there is a limit to increasing the transfer driving force due to problems such as leakage of the ion-exchange resin 10 from the purification tower 100, and thus it is difficult to provide a sufficient transfer driving force. Accordingly, in the apparatus for purifying an aqueous hydrogen peroxide solution according to the present disclosure, the pump 400 is provided downstream of the intermediate storage tank 300. In this case, there is an advantage in that the pump may provide a sufficient transfer driving force to the transfer pipe 500 while solving the problem of leakage of the ion-exchange resin 10.

The apparatus for purifying an aqueous hydrogen peroxide solution according to the present disclosure may include the entire purification apparatus, which includes the above-described components, as a single unit or multiple units, and when the apparatus includes the entire apparatus as multiple units, the ion-exchange resin 10 included in the purification tower 100 may be a resin that is the same as or different from the above-described resin.

When the apparatus for purifying an aqueous hydrogen peroxide solution according to the present disclosure is provided in multiple units, the process of purifying an aqueous hydrogen peroxide solution may be performed repeatedly, thereby improving the purity of the purified aqueous hydrogen peroxide solution.

### <Method for Purifying Aqueous Hydrogen Peroxide Solution>

The method for purifying an aqueous hydrogen peroxide solution according to the present disclosure may be a method of purifying an aqueous hydrogen peroxide solution using the above-described apparatus for purifying an aqueous hydrogen peroxide solution. Specifically, the method may include steps of: (a) performing purification of the aqueous hydrogen peroxide solution by introducing the aqueous hydrogen peroxide solution into a purification tower containing an ion-exchange resin; and (b) discharging the aqueous hydrogen peroxide solution through a discharge pipe connected to the bottom of the purification tower and including a liquid level maintenance portion. In addition, the method may further include, after step (b), steps of: (c) transferring the aqueous hydrogen peroxide solution discharged in step (b) to an intermediate storage tank; and (d) transferring the aqueous hydrogen peroxide solution in the intermediate storage tank to a subsequent process or a final storage tank through a transfer pipe including a pump.

The method for purifying an aqueous hydrogen peroxide solution according to the present disclosure may be a method of purifying an aqueous hydrogen peroxide solution using the above-described apparatus for purifying an aqueous hydrogen peroxide solution, and the contents described above in the section “Apparatus for Purifying Aqueous Hydrogen Peroxide Solution” may be applied to the method without limitation.

### (a) Step of Performing Purification

The method for purifying an aqueous hydrogen peroxide solution according to the present disclosure includes a step of performing purification of the aqueous hydrogen peroxide solution by introducing the aqueous hydrogen peroxide solution into the purification tower 100 containing the ion-exchange resin 10.

The aqueous hydrogen peroxide solution is purified by passing through the ion-exchange resin 10 in the purification tower 100. Specifically, it may be purified by passing from top to bottom through the ion-exchange resin 10.

To this end, the aqueous hydrogen peroxide solution is sprayed onto the top of the ion-exchange resin 10 in the purification tower 100, flows downward through the ion-exchange resin 10, and may be discharged in the subsequent step (b).

As the aqueous hydrogen peroxide solution passes from top to bottom through the ion-exchange resin 10 in the purification tower 100, it is possible to prevent the ion exchange efficiency of the ion-exchange resin 10 from being lowered due to floating of the ion-exchange resin 10, and it is possible to sufficiently improve the purification capacity and purification rate for the aqueous hydrogen peroxide solution without excessively increasing the purification tower.

The amount of aqueous hydrogen peroxide solution supplied from the top of the ion-exchange resin 10 and the amount of aqueous hydrogen peroxide solution discharged from the bottom of the ion-exchange resin 10 are controlled so that the ion-exchange resin 10 may be completely submerged in the aqueous hydrogen peroxide solution 20. These amounts may be controlled so that the level of the aqueous hydrogen peroxide solution 20 is stably maintained through steps (b) to (d) described below.

Here, it is preferable to maintain the level of the aqueous hydrogen peroxide solution 20 in the purification tower 100 at a level equal to or higher than the height of the ion-exchange resin 10 in order to prevent a portion of the ion-exchange resin 10 in the purification tower 100 from being dried by exposure without being submerged in the aqueous hydrogen peroxide solution 20.

By preventing a part of the ion-exchange resin 10 from being dried by exposure without being submerged in the aqueous hydrogen peroxide solution 20 as described above, it is possible to minimize the generation of gas in the process of purifying the aqueous hydrogen peroxide solution, and it is possible to minimize the generation of impurities due to gas while preventing the risk of explosion due to gas generation during the process without expanding facilities, thereby increasing the purification efficiency.

The ion-exchange resin 10 may be packed to a height of 30 to 90%, preferably 30 to 80%, more preferably 30 to 70%, of the internal height of the purification tower 100, taking into consideration the control of gas generated in the purification tower 100 and the efficiency of purification of the aqueous hydrogen peroxide solution. The ion-exchange resin 10 may be selected from among a cation-exchange resin, an anion-exchange resin, and a mixed ion-exchange resin. Among these resins, the mixed ion-exchange resin consisting of a cation-exchange resin and an anion-exchange resin is preferably used considering the efficiency of purification of the aqueous hydrogen peroxide solution.

The cation-exchange resin is not particularly limited as long as it can remove cationic impurities from the aqueous hydrogen peroxide solution. Specifically, the cation-exchange resin may be at least one selected from the group consisting of strongly acidic cation-exchange resins having a polystyrene matrix and a sulfonic acid group.

The anion-exchange resin is not particularly limited as long as it can remove anionic impurities from the aqueous hydrogen peroxide solution. Specifically, the anion-exchange resin may be at least one selected from the group consisting of strongly basic anion-exchange resins having a quaternary ammonium group in the styrene framework. The cation-exchange resin and the anion-exchange resin may be included at a volume ratio of 0.8:1.0 to 1.0:0.8, and when the above volume ratio is satisfied, there is an advantage in that effective mutual purification of impurities generated from each ion-exchange resin is possible, which is preferable.

In the method for purifying an aqueous hydrogen peroxide solution according to the present disclosure, step (a) may be repeatedly performed, and in this case, the ion-exchange resins 10 included in a plurality of purification towers 100 may be of the same type or different types.

### (b) Step of Discharging Aqueous Hydrogen Peroxide Solution

The method for purifying an aqueous hydrogen peroxide solution according to the present disclosure includes a step of discharging the aqueous hydrogen peroxide solution, purified through step (a), through the discharge pipe 200 connected to the bottom of the purification tower 100.

The discharge pipe 200 includes the liquid level maintenance portion 210, and the level of the aqueous hydrogen peroxide solution 20 in the purification tower 100 may be controlled depending on the maximum height of the liquid level maintenance portion 210.

Therefore, it is preferable that the maximum height of the liquid level maintenance portion 210 be equal to or higher than the height of the ion exchange resin 10 so that the ion-exchange resin 10 in the purification tower 100 may be maintained in a state submerged in the aqueous hydrogen peroxide solution 20.

When the maximum height of the liquid level maintenance portion 210 is equal to or higher than the height of the ion-exchange resin 10 in the purification tower 100, the level of the aqueous hydrogen peroxide solution 20 in the purification tower 100 may also be maintained at a level equal to or higher than the height of the ion-exchange resin 10. Thus, in this case, it is possible to fundamentally prevent a portion of the ion-exchange resin 10 in the purification tower 100 from being dried by exposure without being submerged in the aqueous hydrogen peroxide solution 20.

As the level of the aqueous hydrogen peroxide solution 20 in the purification tower 100 is maintained at a level equal to or higher than the height of the ion-exchange resin 10 by means of the liquid level maintenance portion 210 as described above, sufficient time may be secured for the aqueous hydrogen peroxide solution to pass through the ion-exchange resin, thereby increasing the purification efficiency and increasing the purity of the purified aqueous hydrogen peroxide solution.

Furthermore, the maximum height of the liquid level maintenance portion 210 may be 110% or more, preferably 120% or more, of the height of the ion exchange resin 10 in the purification tower 100. When the above numerical range is satisfied, there is an advantage in that, even if there is some swing in the level of the hydrogen peroxide solution 20 in the purification tower 100, the ion-exchange resin may be sufficiently submerged in the aqueous hydrogen peroxide solution, so that even when the purification process is performed, no exposed portion of the ion-exchange resin occurs, and thus the gas generated in the purification process may be controlled more stably.

In addition, the maximum height of the liquid level maintenance portion 210 may be 140% or less, preferably 130% or less, of the height of the ion-exchange resin 10 in the purification tower 100. When the above numerical range is satisfied, there is an advantage in that, even if there is a swing in the level of the aqueous hydrogen peroxide solution in the purification tower, the resin layer is not exposed.

### (c) Step of Transferring Discharged Aqueous Hydrogen Peroxide Solution to Intermediate Storage Tank

The method for purifying an aqueous hydrogen peroxide solution according to the present disclosure may further include a step of transferring the aqueous hydrogen peroxide solution discharged in step (b) to the intermediate storage tank 300.

The level of the aqueous hydrogen peroxide solution in the intermediate storage tank 300 may preferably be 30% or more of the internal height of the intermediate storage tank 300. When this is satisfied, there is an advantage in that it is possible to prevent the pump 400 from idling due to a drop in the level of the aqueous hydrogen peroxide solution.

### (d) Step of Transferring Aqueous Hydrogen Peroxide Solution Through Transfer Pipe

The method for purifying an aqueous hydrogen peroxide solution according to the present disclosure may further include a step of transferring the aqueous hydrogen peroxide solution discharged in step (c) to a subsequent process or a final storage tank through the transfer pipe 500 including the pump 400, wherein the transfer step may be performed using a transfer driving force provided by the pump 400.

In step (c), in order to maintain the level of the aqueous hydrogen peroxide solution in the intermediate storage tank 300, the transfer driving force provided by the pump 400 is preferably controlled to a constant level, and accordingly, the flow rate of the aqueous hydrogen peroxide solution that is transferred through the transfer pipe 500 may be maintained at a constant level.

By maintaining the level of the aqueous hydrogen peroxide solution in the intermediate storage tank 300 at a constant level as described above, the level of the aqueous hydrogen peroxide solution in the purification tower 100 may also be maintained at a constant level.

In the method for purifying an aqueous hydrogen peroxide solution according to the present disclosure, the above-described overall process for purifying an aqueous hydrogen peroxide solution may be repeatedly performed, thereby further increasing the purity of the purified aqueous hydrogen peroxide solution.

Hereinafter, examples of the present disclosure will be described in detail. However, the present disclosure is not limited to the embodiments disclosed below, but may be embodied in various different forms. Rather, these examples are provided so that this disclosure will be thorough and complete, and will fully convey the scope of the present disclosure to those skilled in the art. The scope of the present disclosure will be defined only by the appended claims.

### EXAMPLES AND COMPARATIVE EXAMPLES

### Example 1

According to the purification apparatus illustrated in FIG. 1 and a method of purifying an aqueous hydrogen peroxide solution using the same, an aqueous hydrogen peroxide solution was purified. Specifically, a purification tower with an inner diameter of 700 mm and an internal height of 3,600 mm was packed with a mixed ion-exchange resin (a 1:1 mixture of a cation-exchange resin and an anion-exchange resin) to a height of 33.3% (1,200 mm) of the internal height of the purification tower. Then, an unpurified hydrogen peroxide solution (31%; impurity level: 10 ppb) was introduced into the purification tower through an introduction pipe connected to the top of the purification tower, and the temperature was maintained below 15° C.

The cation-exchange resin of the mixed ion-exchange resin is a strongly acidic ion-exchange resin containing a sulfonic acid group as a functional group and having an ion exchange capacity of 2.0 eq/L and an effective acidity of pH 0 to 14), and the anion-exchange resin is a strongly basic ion-exchange resin containing a quaternary ammonium group as a functional group and having an ion exchange capacity of 1.0 eq/L and an effective acidity of pH 1 to 14.

The purified aqueous hydrogen peroxide solution that passed through the mixed ion-exchange resin was discharged at a flow rate of 1,650 L/hr through a discharge pipe connected to the bottom of the purification tower and including a liquid level maintenance portion having a maximum height of 1,200 mm. The purity of the discharged aqueous hydrogen peroxide solution and the amount of gas generated in the purification tower were evaluated as described below, and the results are shown in Table 2 below.

### Examples 2 to 5

Purification was performed in the same manner as in Example 1, except that the maximum height of the liquid level maintenance portion was as shown in Table 1 below.

### Example 6

According to the purification device shown in FIG. 2 and a method of purifying an aqueous hydrogen peroxide solution using the same, an aqueous hydrogen peroxide solution was purified. Specifically, purification was performed in the same manner as in Example 1, except that the aqueous hydrogen peroxide solution discharged through the discharge pipe was transferred to the intermediate storage tank 300 (inner diameter: 1,000 mm; internal height: 1,500 mm) having the pump 400 provided downstream thereof, and the level of the aqueous hydrogen peroxide solution transferred to the intermediate storage tank was controlled to be maintained at 30% of the internal height of the intermediate storage tank.

### Examples 7 to 9

Purification was performed in the same manner as in Example 6, except that the level of the aqueous hydrogen peroxide solution in the intermediate storage tank was as shown in Table 1 below.

### Examples 10 to 12

Purification was performed in the same manner as in Example 9, except that the maximum height of the liquid level maintenance portion was as shown in Table 1 below.

### Comparative Example 1

Purification was performed in the same manner as in Example 1, except that the purified aqueous hydrogen peroxide solution that passed through the mixed ion-exchange resin was discharged through a discharge pipe connected to the bottom of the purification tower and not including the liquid level maintenance portion, and the level of the aqueous hydrogen peroxide solution in the purification tower was as shown in Table 1 below. The purity of the discharged aqueous hydrogen peroxide solution and the amount of gas generated in the purification tower were evaluated as described below, and the results are shown in Table 2 below.

### Comparative Example 2

Purification was performed in the same manner as in Example 1, except that the purified aqueous hydrogen peroxide solution that passed through the mixed ion-exchange resin was discharged through a discharge pipe connected to the bottom of the purification tower and including a liquid level maintenance portion having a maximum height of 500 mm, and the level of the aqueous hydrogen peroxide solution in the purification tower was as shown in Table 1 below. The purity of the discharged aqueous hydrogen peroxide solution and the amount of gas generated in the purification tower were evaluated as described below, and the results are shown in Table 2 below.

### 1. Method for Evaluation of Purity of Purified Aqueous Hydrogen Peroxide Solution

For the aqueous hydrogen peroxide solutions purified through the Examples and the Comparative Examples, the concentration of sodium ions was measured on a daily basis for two months using an inductively coupled plasma-mass spectrometer (ICP-MS; Agilent, 8900). Evaluation was performed according to the following criteria, and the results are shown in Table 2 below:

### <Criteria for Evaluation of Purity of Purified Hydrogen Peroxide Solution>

⊚: Average sodium ion concentration=0.005 ppb or less
∘: Average sodium ion concentration=more than 0.005 ppb to 0.01 ppb or less
Δ: Average sodium ion concentration=more than 0.01 ppb to 0.02 ppb or less
x: Average sodium ion concentration=more than 0.02 ppb

### 2. Method for Evaluation of Amount of Gas Generated in Purification Tower

The amount of gas generated in the purification tower was measured for 1 week using a gas flow meter installed on the top of the purification tower. Evaluation was performed according to the following criteria, and the results are shown in Table 2 below:

### <Criteria for Evaluation of Amount of Gas Generated in Purification Tower>

∘: amount of gas generated=less than 7 L/hr
Δ: amount of gas generated=7 L/hr to less than 10 L/hr
x: amount of gas generated=10 L/hr or more

TABLE 1

| | | Maximum height | | Level (mm) of | Level (mm) of aqueous | |
|---|---|---|---|---|---|---|
| | | of liquid level | | aqueous hydrogen | hydrogen peroxide solution | |
| | Ion-exchange | maintenance | | peroxide solution | in purification tower | |
| | resin height (I) | portion (H) | H/I*100 | in intermediate | | After |
| | (mm) | (mm) | (%) | storage tank | Initial | 120 min |
| Example 1 | 1200 | 1200 | 100 | — | 1200 | 1200 |
| Example 2 | 1200 | 1500 | 125 | — | 1500 | 1500 |
| Example 3 | 1200 | 1350 | 113 | — | 1350 | 1350 |
| Example 4 | 1200 | 1600 | 133 | — | 1600 | 1600 |
| Example 5 | 1200 | 1300 | 108 | — | 1300 | 1300 |
| Example 6 | 1200 | 1200 | 100 | 450 | 1200 | 1200 |
| Example 7 | 1200 | 1500 | 125 | 750 | 1500 | 1500 |
| Example 8 | 1200 | 1500 | 125 | 900 | 1500 | 1500 |
| Example 9 | 1200 | 1500 | 125 | 825 | 1500 | 1500 |
| Example 10 | 1200 | 1350 | 113 | 825 | 1350 | 1350 |
| Example 11 | 1200 | 1600 | 133 | 825 | 1600 | 1600 |
| Example 12 | 1200 | 1300 | 108 | 825 | 1300 | 1300 |
| Comparative | 1200 | — | — | 750 | 1500 | * |
| Example 1 | | | | | | |
| Comparative | 1200 | 500 | 41.7 | 750 | 1500 | * |
| Example 2 | | | | | | |

(* Not measurable because the level of the aqueous hydrogen peroxide solution was lower than the height of the ion-exchange resin)

TABLE 2

| | Purity of purified | Amount of gas |
|---|---|---|
| | aqueous hydrogen | generated in |
| | peroxide solution | purification tower |
| Example 1 | ◯ | Δ |
| Example 2 | ⊚ | ◯ |
| Example 3 | ⊚ | ◯ |
| Example 4 | ⊚ | ◯ |
| Example 5 | ◯ | ◯ |
| Example 6 | ⊚ | Δ |
| Example 7 | ⊚ | ◯ |
| Example 8 | ⊚ | ◯ |
| Example 9 | ⊚ | ◯ |
| Example 10 | ⊚ | ◯ |
| Example 11 | ⊚ | ◯ |
| Example 12 | ⊚ | ◯ |
| Comparative | Δ | X |
| Example 1 | | |
| Comparative | Δ | X |
| Example 2 | | |

Reference Numeral

| | |
|---|---|
| 10: Ion-exchange resin | 20: Aqueous hydrogen peroxide solution |
| 100: Purification tower | 130: Injection pipe |
| 200: Discharge pipe | 210: Liquid level maintenance portion |
| 300: Intermediate storage tank | 400: Pump |
| 500: Transfer pipe | |

What is claimed is:

1. A method for purifying an aqueous hydrogen peroxide solution, comprising steps of:
(a) performing purification of the aqueous hydrogen peroxide solution by introducing the aqueous hydrogen peroxide solution into a purification tower containing an ion-exchange resin; and
(b) discharging the aqueous hydrogen peroxide solution through a discharge pipe connected to a bottom of the purification tower and comprising a liquid level maintenance portion,
wherein, in step (a), the aqueous hydrogen peroxide solution is passed from top to bottom through the ion-exchange resin, and
in step (b), a maximum height of the liquid level maintenance portion is equal to or greater than a height of the ion-exchange resin in the purification tower.

2. The method of claim 1, wherein the maximum height of the liquid level maintenance portion is 110% or more of the height of the ion-exchange resin in the purification tower.

3. The method of claim 1, wherein the maximum height of the liquid level maintenance portion is 120% or more of the height of the ion-exchange resin in the purification tower.

4. The method of claim 1, wherein the maximum height of the liquid level maintenance portion is 140% or less of the height of the ion-exchange resin in the purification tower.

5. The method of claim 1, wherein the maximum height of the liquid level maintenance portion is 130% or less of the height of the ion-exchange resin in the purification tower.

6. The method of claim 1, wherein the ion-exchange resin is a mixed ion exchange resin consisting of a cation-exchange resin and an anion-exchange resin.

7. The method of claim 1, further comprising, after step (b), steps of:
(c) transferring the aqueous hydrogen peroxide solution discharged in step (b) to an intermediate storage tank; and
(d) transferring the aqueous hydrogen peroxide solution in the intermediate storage tank to a subsequent process or a final storage tank through a transfer pipe including a pump.

8. The method of claim 7, wherein a level of the hydrogen peroxide solution in the intermediate storage tank is 30% or more of an internal height of the intermediate storage tank.

9. The method of claim 7, wherein step (d) is performed using a transfer driving force provided by the pump.

10. The method of claim 1, wherein an entire process comprising steps (a) and (b) is repeated to further increase the purity of the purified aqueous hydrogen peroxide solution.

11. An apparatus for purifying an aqueous hydrogen peroxide solution, comprising:
a purification tower containing an ion-exchange resin; and
a discharge pipe connected to a bottom of the purification tower and comprising a liquid level maintenance portion,
wherein a maximum height of the liquid level maintenance portion is equal to or greater than a height of the ion-exchange resin in the purification tower.

12. The apparatus of claim 11, wherein the maximum height of the liquid level maintenance portion is 110% or more of the height of the ion-exchange resin in the purification tower.

13. The apparatus of claim 11, wherein the maximum height of the liquid level maintenance portion is 120% or more of the height of the ion-exchange resin in the purification tower.

14. The apparatus of claim 11, wherein the maximum height of the liquid level maintenance portion is 140% or less of the height of the ion-exchange resin in the purification tower.

15. The apparatus of claim 11, wherein the maximum height of the liquid level maintenance portion is 130% or less of the height of the ion-exchange resin in the purification tower.

16. The apparatus of claim 11, wherein the ion-exchange resin is a mixed ion exchange resin consisting of a cation-exchange resin and an anion-exchange resin.

17. The apparatus of claim 11, further comprising an intermediate storage tank connected to the discharge pipe.

18. The apparatus of claim 17, wherein a rear end of the intermediate storage tank is connected to a transfer pipe, wherein the transfer pipe includes a pump.
